(19) United States
(12) Patent Application Publication
(10) Pub. No.: US 2014/0016256 A1
(43) Pub. Date: Jan. 16, 2014

(54) CONTAINER DATA CENTER

(71) Applicant: TAI-WEI LIN, Tu-Cheng (TW)

(72) Inventor: TAI-WEI LIN, Tu-Cheng (TW)

(73) Assignee: HON HAI PRECISION INDUSTRY CO., LTD., Tu-Cheng (TW)

(21) Appl. No.: 13/568,114

(22) Filed: Aug. 6, 2012

(30) Foreign Application Priority Data
Jul. 16, 2012 (TW) 101125521

(51) Int. Cl. G06F 1/20

(52) U.S. Cl. 361/679.5; 361/679.49

(57) ABSTRACT

A container data center includes a container, a number of rack servers arranged in the container, and an air-conditioning device arranged in the container. The air-conditioning device defines a vent. A fan module is mounted in the vent, for blowing cooling air generated by the air-conditioning device to the rack servers.

### BACKGROUND

1. Technical Field

The present disclosure relates to a container data center.

2. Description of Related Art

With increasing use of online applications, the need for computer data centers has increased rapidly. Data centers are centralized computing facilities that include many rack servers. During operation, server systems generate a great amount of heat in the data centers, and a common method for dissipating the heat is to define a cooling room, which is cooled by an air-conditioning device. The air-conditioning device generates the same cooling airflow to the rack servers, but cannot supply different cooling airflow according to the different needs of the rack servers.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a container data center, according to an exemplary embodiment.

FIG. 2 is a partial, block diagram view of the container data center of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

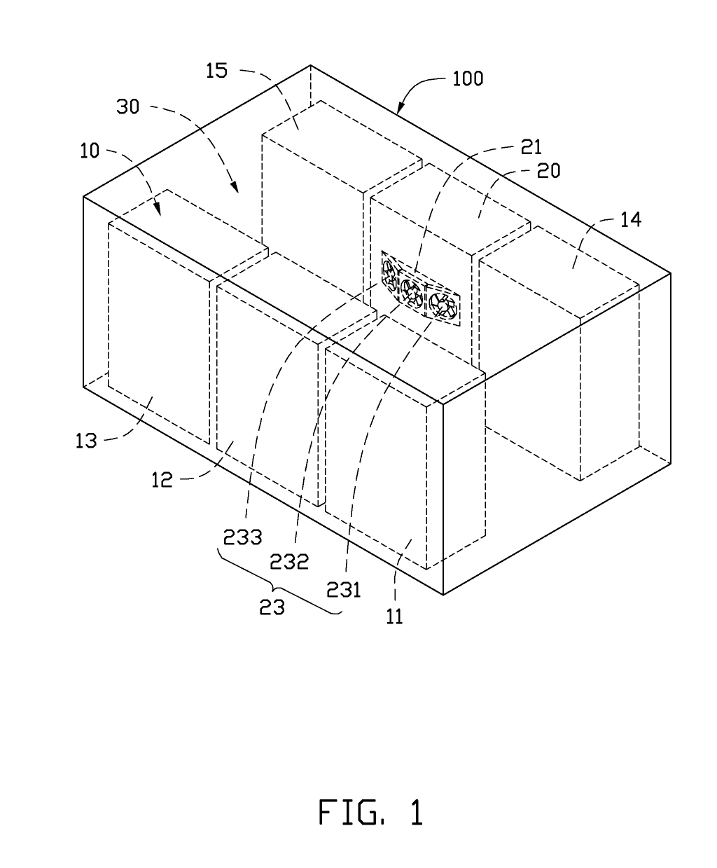

Referring to FIG. 1, an embodiment of a container data center is shown. The container data center includes a container 100, two rows of rack servers 10 arranged in the container 100, and an air-conditioning device 20.

The container 100 includes a cooling room 30 defined between the rows of rack servers 10. A first row of the rack servers 10 includes a first rack server 11, a second rack server 12, and a third rack server 13. A second row of the rack servers 10 includes a fourth rack server 14 and a fifth rack server 15. The air-conditioning device 20 is located between the fourth rack server 14 and the fifth rack server 15.

The air-conditioning device 20 defines a vent 21 communicating with the cooling room 30. A fan module 23 is arranged in the vent 21. In this embodiment, the fan module 23 includes a first fan 231, a second fan 232, and a third fan 233 all pivotably mounted in the vent 21 and respectively facing the first rack server 11, the second rack server 12, and the third rack server 13.

When the container data center operates, the air-conditioning device 20 operates to generate cooling air. The fan modules 12 operate to draw cooling air from the air-conditioning device 20 into the cooling room 30. The rack servers 10 then absorb the cooling air in the cooling room 30 for cooling. In the embodiment, the first fan 231 blows cooling air to a space of the cooling room 30 between the first rack server 11 and the fourth rack server 14, to cool the first rack server 11 and the fourth rack server 14. The second fan 232 blows cooling air toward the second rack server 12. The third fan 233 blows cooling air to a space of the cooling room 30 between the third rack server 13 and the fifth rack server 15, to cool the third rack server 13 and the fifth rack server 15.

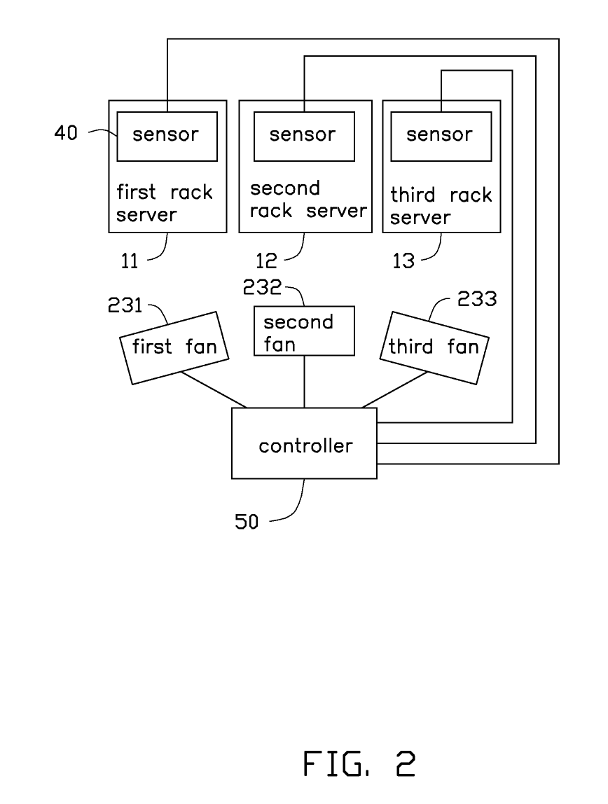

Referring to FIG. 2, each of the rack servers 10 receives a sensor 40. The sensors 40 sense the temperature in the rack servers 10 and transmit the temperature signals about the sensed temperature to a controller 50. When the controller 50 receives a high temperature signal, the controller 50 will speed up the corresponding fan, to send more cooling air to the corresponding rack server 10, which feeds back the high temperature signal. For example, when the controller 50 receives a high temperature signal from the first rack server 11, the controller 50 will speed up the first fan 231, to send more cooling air to the first rack server 11. At the same time, if the controller 50 receives a low temperature signal from the second rack server 12 or the third rack server 13, the controller 50 will control the second fan 232 or the third fan 233 to rotate to face the first rack server 11, to send more cooling air to the first rack server 11.

In other embodiments, the air-conditioning device 20 may be located at one end of the cooling room 30 or a top of the cooling room 30.

In the embodiment, the fan module 23 is mounted in the vent 21 of the air-conditioning device 20, to draw cooling air from the air-conditioning device 20 and blow the cooling air toward the rack servers 10. The speed and the facing direction of the fan module 23 can be adjusted to adjust the cooling airflow toward the different rack servers 10, which can supply different cooling airflow according to the different needs of the rack servers 10.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A container data center, comprising:
a container;
a plurality of rack servers arranged in the container; and
an air-conditioning device arranged in the container, wherein the air-conditioning device defines a vent, a fan module is arranged in the vent, to draw cooling air generated by the air-conditioning device and blow the cooling air toward the rack servers.

2. The container data center of claim 1, the container defines a cooling room, the vent of the air-conditioning device communicating with the cooling room.

3. The container data center of claim 2, wherein the plurality of rack servers is arranged in two rows, the cooling room is defined between the rows of rack servers, the air-conditioning device is located between two rack servers of one of the two rows of rack servers.

4. The container data center of claim 2, wherein the air-conditioning device is located at one end of the cooling room or a top of the cooling room.

5. The container data center of claim 1, wherein the fan module comprises a plurality of fans pivotably mounted in the vent.

6. The container data center of claim 1, wherein a sensor is arranged in each of the rack servers, the sensors sense the temperature in the rack servers and transmit temperature signals about the sensed temperature to a controller, the controller controls the speed of the fan module.

7. The container data center of claim 1, wherein a sensor is arranged in each of the rack servers, the sensors sense the temperature in the rack servers and transmit temperature signals about the sensed temperature to a controller, the controller controls the facing direction of the fan module.
